(19) United States
(12) Patent Application Publication
(10) Pub. No.: US 2001/0032716 A1
(43) Pub. Date: Oct. 25, 2001

(54) Heat exchanger element

(76) Inventor: Wolf-Dieter Consilius, Kerpen (DE)

Correspondence Address: Friedrich Kueffner, Suite 1921, 342 Madison Avenue, New York, NY, 10173, US

(21) Appl. No.: 09/802,319

(22) Filed: Mar. 8, 2001

(30) Foreign Application Priority Data
Mar. 9, 2000 (DE) 100 11 568.3

(51) Int. Cl. F28F 7/00; F28F 3/14; B23P 15/26; B21D 39/06; B21D 53/02; B21D 53/04; B21D 53/06; B21D 53/08

(52) U.S. Cl. 165/80.5; 165/170; 29/890.039

(57) ABSTRACT

A heat exchanger element has at least two stacked metal sheets connected to one another such that flow channels are formed between facing sides of the metal sheets. The flow channels allow flow of a heat exchanger medium therethrough. The metal sheets are made of a reactive metal and are connected by electron beam welding in vacuum. The heat exchanger elements are manufactured by introducing at least two metal sheets into a hermetically sealed vacuum chamber and partially connecting by electron beam welding in vacuum the at least two metal sheets to one another to form an intermediate product. The intermediate product is further processed to build a heat exchanger element.

### BACKGROUND OF THE INVENTION

1. Field of the Invention

The invention relates to a heat exchanger element which comprises at least two metal sheets that are stacked and connected to one another, wherein between the metal sheets flow channels for allowing flow of a heat exchanger medium are formed.

2. Description of the Related Art

Such heat exchanger elements, referred to in the art as thermal sheets, are used in various industrial processes. They ensure an efficient heat transfer. In this connection, the flow channel or the flow channels are supplied via corresponding connectors with a liquid, vapor or gaseous heat exchanger medium which is provided either for supplying or removing heat energy. The heat transfer away from or into the actual process medium takes place at the outer surface of the thermal sheets. The process medium can be present in the solid state, for example, as a powder, a liquid state, gaseous state, or vapor state. The physical state of the process medium at the outer side of the thermal sheets may remain the same when increasing or decreasing the temperature by heat exchange, for example, in connection with cooling or heating processes. However, the physical state may also change, for example, in the case of condensation, vaporization, crystallization, or melting processes.

For manufacturing heat exchanger elements, two or more metal sheets of identical wall thickness or different wall thickness are connected with one another in a stacked arrangement by laser welding or resistance welding. The welding contours within the metal sheet package can be selected to match the respective requirements. In general, a differentiation is made between metal sheets with a spot pattern and metal sheets with a defined channel extension. Subsequently, the edges of a metal sheet package are tightly sealed by a continuous welding seam. The space between the individual metal sheets is widened permanently by applying pressure with a pressure medium. This results in a defined plastic deformation of the metal sheets between the welding seams and in the formation of flow channels. In principle, the contours of the flow channels can also be formed before connecting the metal sheets. Depending on the configuration, the planar metal sheet packages are also pre-shaped before widening to form cylindrical or conical heat exchanger elements.

The metal sheets used in this connection may be completely flat or can be pre-shaped by providing grooves and folds. Also, it is known to provide circular or slot-shaped openings in one of the metal sheets for producing so-called plug welds or slot welds. Also, the thickness of the metal sheets connected to one another can vary.

In the conventional configurations of heat exchanger elements of today, known welding methods are used in order to connect the metal sheets to one another. These include resistance welding as spot welding and/or roll seam welding, the tungsten inert-gas method (TIG welding) as well as plasma welding or laser welding.

In these welding methods, the material of the metal sheets is melted at the surface in an open ambient atmosphere or in an inert gas envelope, for example, an argon envelope, which can be controlled to a greater or lesser degree. Therefore, sheets of stainless steels or steel alloys are employed which can be processed with the aforementioned welding methods.

The known heat exchanger elements have basically proven successful in practice.

The field of application of the known heat exchanger elements is, however, limited by the environmental conditions and operating parameters that are present. The heat exchanger elements of the metallic materials which are weldable with the aforementioned welding methods reach their limit, in particular, when used in aggressive acidic environments.

### SUMMARY OF THE INVENTION

It is an object of the present invention to provide a heat exchanger element for use in an aggressive environment and to provide a method for its manufacture.

In accordance with the present invention, this is achieved in that the metal sheets are comprised of a reactive metal and are connected to one another by means of electron beam welding in vacuum.

The principal idea of the invention is the measure of providing metal sheets of a reactive metal for manufacturing the heat exchanger elements. In this connection, the tern reactive metal refers to metals of the fifth group of the transition elements of the periodic table, such as tantalum or niobium. These metals are characterized by a high chemical resistance as well as a high melting temperature. Based on the fact that these metals take up oxygen and nitrogen when exposed to heat, they are also referred to as reactive metals. These materials are therefore not suitable for conventional welding methods because they become irreversibly brittle as a result of take-up of traces of oxygen and nitrogen from the surrounding atmosphere in the molten phase of the welding process as well as in the basic material in the areas exposed to heat. According to the invention, the irreversible brittleness of the material as a result of taking up oxygen and/or nitrogen during the welding process is prevented in that the metal sheets are connected by means of electron beam welding in vacuum.

The invention provides a heat exchanger element (thermal sheet) which is suitable for use in extremely aggressive environments. In comparison to conventional tubular apparatus, the heat exchanger element has process-technological advantages. Also, the area-specific manufacturing costs are reduced in comparison to tubular apparatus.

Particularly advantageous are heat exchanger elements whose metal sheets are comprised of tantalum or of a tantalum-tungsten alloy. Tantalum is resistant with respect to almost all acids and their mixtures within wide concentration ranges even at higher temperatures, for example, resistant to phosphoric acid, hydrochloric acid, nitric acid, sulfuric acid and acetic acid. Also, chlorine gas and bromine in the humid as well as the dry state do not attack tantalum at least up to a temperature of 250° C.

Niobium is also a metal which does not dissolve in acids and is therefore suitable for use according to the invention.

Moreover, a tantalum-niobium alloy has great advantages in practice.

The method according to the invention is characterized in that at least two metal sheets are partially welded together in a hermetically closed chamber in vacuum by means of electron beam welding and the resulting intermediate product is subsequently further processed to the heat exchanger element. Since the reactive metals, such as tantalum, tantalum-tungsten alloys, niobium, and tantalum-niobium alloys, cannot be welded by the conventional fusion-based welding methods with the required welding quality for the desired purpose according to the invention because they become brittle in the areas exposed to heat, the metal sheets are partially welded together in a hermetically sealed chamber in vacuum by means of electron beam welding. Subsequently, the thus produced intermediate product can be further processed in a conventional way to the heat exchanger element. In the chamber, which is preferably under high vacuum with pressure conditions between 10⁻⁴ and 10⁻¹ Pa, the welding-technological connection between two or more metal sheets to a metal sheet package is performed with exclusion of any damaging effects by foreign gases.

### BRIEF DESCRIPTION OF THE DRAWING

In the drawing:

FIG. 1 is a perspective illustration of a section of a heat exchanger element;

FIG. 2 shows the heat exchanger element of FIG. 1 in a plan view;

FIG. 3 is a perspective illustration of a section of a second embodiment of a heat exchanger element;

FIG. 4 shows the heat exchanger element of FIG. 3 in a plan view.

### DESCRIPTION OF THE PREFERRED EMBODIMENTS

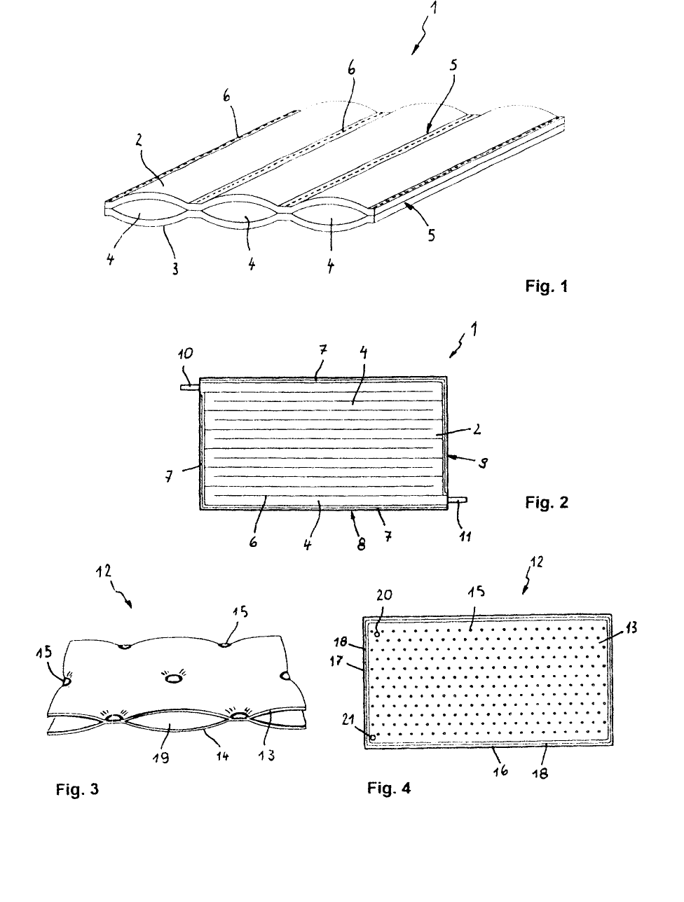

FIG. 1 shows in a schematic and greatly simplified illustration a section of a heat exchanger element, a so-called thermal sheet 1. A plan view of the thermal sheet 1 is shown in FIG. 2. Such thermal sheets 1 are used for heat exchange in various industrial processes.

The thermal sheet 1 comprises substantially two metal sheets 2, 3 stacked and connected to one another between which flow channels 4 for the flow of heat exchanger medium are formed.

The two metal sheets 2 and 3 are comprised of a reactive metal, in particular, tantalum, a tantalum-tungsten alloy, niobium, or a tantalum-niobium alloy. As a result of the high chemical resistance of these metals, the thermal sheet metal 1 is suitable for use in aggressive acidic process environments. The aforementioned metals, however, take up oxygen and nitrogen when exposed to heat and will thus become brittle in the area of exposure to the heat of welding. This is prevented according to the invention in that the two metal sheets 2, 3 are partially welded together in a hermetically closed chamber (not shown) in vacuum by means of electron beam welding. In this way, the connection by welding is carried out with exclusion of any damaging effects by foreign gases. The two metal sheets 2, 3 are welded to one another without any processes causing disadvantageous brittleness in the connecting areas 5 taking place. The welding seams 6 are illustrated in FIG. 1 in a technically simplified illustration by the dashed lines. FIG. 2 shows that the two metal sheets 2, 3 are welded together by edge welding 7 along their outer edges 8, 9.

Even though only two metal sheets 2 and 3 are illustrated in the drawing, it is possible, in principle, to connect by a single working process several metal sheets in a stacked arrangement to a metal sheet package.

After completion of the welding-technological connection in a further processing step the flow channels 4 are widened by a directed pressure application of the areas between the welding seams 6. Before the widening process is carried out, a metal sheet package can also be formed to a cylindrical or conical body. During the course of the final manufacture, the flow channels 4 are provided with lateral connectors 10, 11 for supplying or removing a process medium.

The channel height and the channel cross-section of the flow channels 4 can be matched basically to the specific requirements as regards the amount of medium flowing through and the operating pressure.

FIGS. 3 and 4 show a thermal sheet 12 that, in contrast to the defined channels of the thermal sheet 1, is provided with a spot welding pattern.

The thermal sheet 12 is also formed of two stacked and connected metal sheets 13, 14 of a reactive metal. As mentioned above, particularly metal sheets 13, 14 comprised of tantalum, a tantalum-tungsten alloy, niobium or a tantalum-niobium alloy can be used. The metal sheets 13, 14 are connected by an electron beam welding process in vacuum by means of welding spots 15 distributed about the surface area. Subsequently, the edges 16, 17 of the metal sheet package are tightly closed by a continuous welding seam 18. The spacing between the individual welding spots 15 as well as the wall thickness of the metal sheets 13, 14 are determined according to the requirements with regard to the amount of throughput of the medium, permissible operating over-pressure, and pressure drop.

The space between the individual metal sheets 13, 14 is widened permanently by pressing a pressure medium into it. Accordingly, the thermal sheet 12 has a pillow-shaped surface structure with approximately elliptical flow channels 19. This results in a permanent turbulent flow without dead flow areas. With this configuration, excellent heat transfer properties can be obtained.

The connectors 20, 21 required for supply and removal of the process medium are butt-jointed on the thermal sheet 12.

Because of the high chemical resistance of the thermal sheet 12 it is especially suitable for use in heat exchanger processes in which aggressive cooling or heating media such as phosphoric acid, hydrochloric acid, nitric acid, sulfuric acid or acetic acid are used. Further examples of aggressive process media, with respect to which the thermal sheet 12 is resistant, are chlorine gas and bromine.

While specific embodiments of the invention have been shown and described in detail to illustrate the inventive principles, it will be understood that the invention may be embodied otherwise without departing from such principles.

What is claimed is:

1. A heat exchanger element comprising at least two stacked metal sheets connected to one another such that flow channels are formed between facing sides of the metal sheets, which flow channels are configured to allow flow of a heat exchanger medium therethrough, wherein the metal sheets are comprised of a reactive metal, and wherein the metal sheets are configured to be connected by electron beam welding in vacuum.

2. The heat exchanger element according to claim 1, wherein the reactive metal is tantalum.

3. The heat exchanger element according to claim 1, wherein the reactive metal is a tantalum-tungsten alloy.

4. The heat exchanger element according to claim 1, wherein the reactive metal is niobium.

5. The heat exchanger element according to claim 1, wherein the reactive metal is a tantalum-niobium alloy.

6. A method for manufacturing heat exchanger elements according to claim 1, comprising the steps of:
introducing at least two metal sheets into a hermetically sealed vacuum chamber;
partially connecting by electron beam welding in vacuum the at least two metal sheets to one another to form an intermediate product; and
further processing the intermediate product to build a heat exchanger element.
